(19) United States
(12) Patent Application Publication
(10) Pub. No.: US 2012/0229451 A1
(43) Pub. Date: Sep. 13, 2012

(54) METHOD, SYSTEM AND APPARATUS FOR DISPLAY AND BROWSING OF E-BOOKS

(75) Inventors: Wong Hoo SIM, Singapore (SG); Teck Chee LEE, Singapore (SG); Qiang QIAN, Singapore (SG); Hon Wai CHOONG, Singapore (SG)

(73) Assignee: CREATIVE TECHNOLOGY LTD, Singapore (SG)

(21) Appl. No.: 13/343,622

(22) Filed: Jan. 4, 2012

(30) Foreign Application Priority Data
Mar. 7, 2011 (SG) 201101667-2

(51) Int. Cl. G06T 15/00

(52) U.S. Cl. 345/419

(57) ABSTRACT

An electronic reader device configured to receive at least one set of source data for processing in a manner so as to display at least one electronic reading material. The electronic reader device includes a processing portion and a display portion coupled to the processing portion. The processing portion can be configured to process at least one set of source data in a manner so as to produce graphic data. Graphic data can be communicated to the display portion which can be configured to display graphic data as display data in a stereoscopic display mode. The display data can correspond to a graphic representation. In the stereoscopic display mode, the graphic representation is associable with a three dimensional imaging based graphic representation such that the display data correspond to a graphic representation where at least one portion of the at least one electronic reading material is visually perceivable to be projecting from the display portion.

### FIELD OF INVENTION

The present disclosure generally relates to information storage, processing and display. More particularly, various embodiments of the disclosure relate to a system, a device and a processing method suitable for digitally rendering and displaying electronic reading materials in a manner so as to provide an enhanced browsing experience.

### BACKGROUND

Various advances in technology have given rise to advancement in information storage and display techniques. For example, paper based reading materials in general, such as books or magazines, can be rendered into electronic form from paper form due to various advances in digital processing techniques.

An electronic form of a paper based reading material can generally be referred to as an electronic book (e-book). A reading device such as an e-book reader is usually required to one or both of store and display one or more e-books. Particularly, an e-book reader can be used by a user to browse and view e-books. An e-book reader can include a screen configured to display one or more e-books.

Various conventional display and rendering techniques can be implemented for the purposes of user browsing and viewing of e-books using an e-book reader.

Conventional display and rendering techniques can include providing one or more e-books and displaying an e-book via plane based display techniques. Particularly, display of content data associated with the e-book can be associated with plane based display techniques.

Generally, for plane based display techniques, content data of the e-book can be visually perceived to be level with respect to the screen of the e-book reader. Particularly, content data associated with the e-book can be viewed in a manner akin to how an electronic document, such as a word document, is viewed on, for example, a computer screen which is analogous to the screen of an e-book reader.

However, plane based display techniques may be associated with a number of problems which may detract user browsing and viewing experience. For example, displaying an e-book using plane based display techniques may not provide enjoyable browsing and viewing experience for users who may prefer browsing paper based reading materials. Thus, conventional display and rendering techniques, unfortunately, fail to facilitate user browsing and viewing of e-books such that a realistic browsing experience, comparable to that of browsing a paper based reading material, can be attained.

It is therefore desirable to provide a solution to address at least one of the foregoing problems of conventional display and rendering techniques.

### SUMMARY OF THE INVENTION

In accordance with a first aspect of the disclosure, an electronic reader device, which can be configured to receive at least one set of source data for processing in a manner so as to display at least one electronic reading material, is provided. The at least one electronic reading material can include a plurality of digitally rendered pages. Each of the plurality of digitally rendered pages can include a first edge and a second edge.

The electronic reader device includes a processing portion and a display portion. The display portion can be coupled to the processing portion.

The processing portion can be configured to process at least one set of source data in a manner so as to produce graphic data.

Graphic data can be communicated from the processing portion to the display portion. The display portion can be configured to display graphic data as display data in a stereoscopic display mode and the display data can correspond to a graphic representation.

In the stereoscopic display mode, the graphic representation is associable with a three dimensional imaging based graphic representation such that the display data correspond to a graphic representation where at least one portion of the at least one electronic reading material is visually perceivable to be projecting from the display portion.

In accordance with a second aspect of the disclosure, an electronic reader device, which can be configured to receive at least one set of source data for processing in a manner so as to display at least one electronic reading material, is provided. The at least one electronic reading material can include a plurality of digitally rendered pages. Each of the plurality of digitally rendered pages can include a first edge and a second edge.

The electronic reader device includes a processing portion and a display portion. The display portion can be coupled to the processing portion.

The processing portion can be configured to process at least one set of source data in a manner so as to produce graphic data.

Graphic data can be communicated from the processing portion to the display portion. The display portion can be configured to display graphic data as display data. The display data can correspond to a graphic representation where the first edge of a digitally rendered page is visually perceivable to be projecting from the display portion when the digitally rendered page is flipped in one of a first direction and a second direction.

In accordance with a third aspect of the disclosure, an electronic reader device, which can be configured to receive at least one set of source data for processing in a manner so as to display at least one electronic reading material, is provided. The at least one electronic reading material can include a plurality of digitally rendered pages. Each of the plurality of digitally rendered pages can include a first edge and a second edge.

The electronic reader device includes a processing portion and a display portion. The display portion can be coupled to the processing portion.

The processing portion can be configured to process at least one set of source data in a manner so as to produce graphic data.

Graphic data can be communicated from the processing portion to the display portion. The display portion can be configured to display graphic data as display data in one of a plane based display mode and a stereoscopic display mode. The display data can correspond to a graphic representation.

When in the plane based display mode, the graphic representation is associable with a two dimensional imaging based graphic representation, and when in the stereoscopic display mode, the graphic representation is associable with a three dimensional imaging based graphic representation.

### BRIEF DESCRIPTION OF THE DRAWINGS

Embodiments of the disclosure are described hereinafter with reference to the following drawings, in which:

FIG. 1 shows a system which includes a source portion and a device, according to an embodiment of the disclosure;

FIG. 2 shows the device of the system of FIG. 1 in further detail, wherein the device can include an input portion, a processing portion and a display portion, according to an embodiment of the disclosure;

FIG. 3 shows an exemplary implementation of the device of the system of FIG. 1, wherein the device can be an electronic reader device such as an e-book reader having a display screen and the e-book reader is usable by a user for browsing one or more e-books;

FIG. 4a to FIG. 4c show various rendering strategies associated with display of display data by the e-book reader of FIG. 3 when the display screen is configured for display in stereoscopic display mode; and

FIG. 5 shows a flow diagram for a processing method which can be implemented in association with the system of FIG. 1, according to an embodiment of the disclosure.

### DETAILED DESCRIPTION

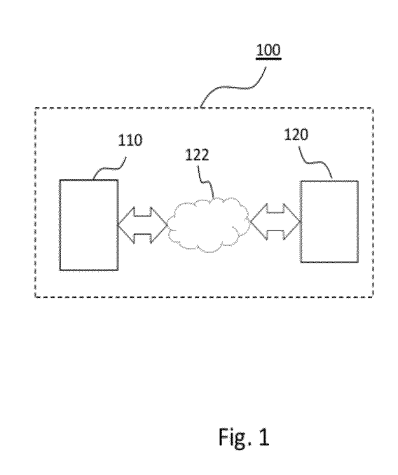

Representative embodiments of the disclosure for addressing one or more of the foregoing problems associated with conventional display and rendering techniques are described hereinafter with reference to FIG. 1 to FIG. 5.

A system 100, which includes a source portion 110 and a device 120, is shown in FIG. 1, in accordance with an embodiment of the disclosure. The source portion 110 is coupled to the device 120 in a manner such that the device 120 can data communicate with the source portion 110.

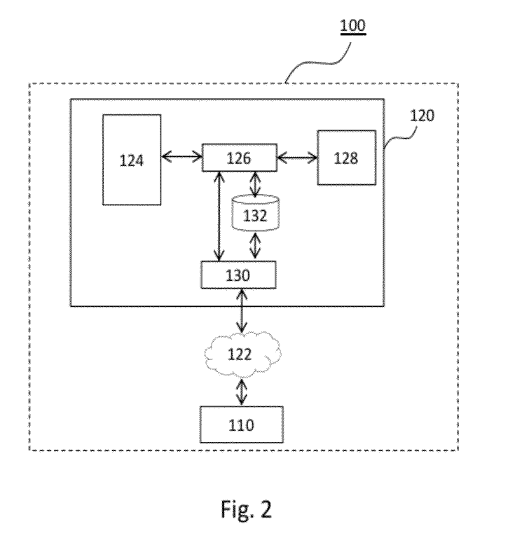

The source portion 110 can be configured to provide one or more sets of source data which can be data communicated to the device 120 for processing in a manner which will be discussed later in further detail in with reference to FIG. 2.

The source portion 110 can, for example, be coupled to the device 120 via a communication network 122. In this regard, the device 120 can be configured to data communicate with the source portion 110 via the communication network 122. More specifically, the source portion 110 can be configured to data communicate one or more sets of source data to the device 120 via the communication network 122.

The communication network 122 can be one or both of a wired communication network and a wireless communication network. In this regard, the device 120 can be configured to data communicate with the source portion 110 via one or both of wired based communication and wireless based communication.

Additionally, the source portion 110 can include one or more input sources associable with, for example, one or more electronic based reading materials such as electronic-books (e-books). For example, the source portion 110 can be a World Wide Web (WWW) based source which is associable with a library of e-books.

In general, an e-book, as mentioned earlier, can be considered a digital equivalent of a paper based reading material such as a book or a magazine. Specifically, a paper based reading material can be digitally rendered to produce an e-book.

A paper based reading material can include pages of reading content. The reading content can include one or both of literary works and pictorial illustrations. Thus each page of the paper based reading material can be associated with one or both of literary works and pictorial illustrations. In this regard, an e-book can include digitally rendered pages corresponding to the aforementioned pages of reading content. Thus each digitally rendered page of the e-book can correspond to each page of the paper based reading material. Thus a digitally rendered page of each e-book within the library of e-books can include content data corresponding to one or both of literary works and pictorial illustrations associated with a paper based reading material.

In this regard, each e-book within the library of e-books can be associable with a set of source data communicable from the source portion 110. Thus a set source data communicated from the source portion 110 can be associated with the content data.

The one or more sets of source data received by the device 120 can correspond to a collection of e-books which can be suitably displayed by the device 120 in a manner such that a user of the device 120 can browse the collection of e-books and select one or more e-books from the collection of e-books for viewing. In this regard, the device 120 can, for example, be an e-book reader which can be configured to browse a collection of e-books and select one or more e-books from the collection of e-books for user viewing.

Referring to FIG. 2, the device 120 is shown in further detail. The device 120 can include an input portion 124, a processing portion 126 and a display portion 128. The input portion 124 can be coupled to the processing portion 126. The processing portion 126 can be coupled to the display portion 128. The device 120 can optionally include a communication portion 130 and a database portion 132.

In one embodiment, the device 120 can be configured to data communicate with the source portion 110 via the communication portion 130 in a manner such that one or more sets of source data can be communicated from the source portion 110 to the device 120 for processing by the device 120. In this regard, the communication portion 130 can be coupled to the source portion 110. Additionally, the communication portion 130 can also be coupled to the processing portion 126 in a manner such that at least one set of source data can be received and processed by the processing portion 126.

In another embodiment, the device 120 can be configured to data communicate with the source portion 110 via the communication portion 130 in a manner such that one or more sets of source data communicated from the source portion 110 can be received and stored in the database portion 132 as corresponding one or more sets of stored data. The one or more sets of stored data can be communicated from the database portion 132 to the processing portion 126 for processing. In this regard, the communication portion 130 can be coupled to the source portion 110. Additionally, the communication portion 130 can also be coupled to the database portion 132 which can be coupled to the processing portion 126.

In yet another embodiment, the device 120 can be configured to data communicate with the source portion via the communication portion 130 in a manner such that one or more sets of source data communicated from the source portion 110 can be received by the processing portion 126 and the database portion 132. The one or more sets of source data received by the database portion 132 can be stored therein as corresponding one or more sets of stored data. In this regard, the communication portion 130 can be coupled to the source portion 110. Additionally, the communication portion 130 can also be coupled to the processing portion 126 and the database portion 132. The database portion 132 can be further coupled to the processing portion 126. Thus the processing portion 126 can be configured to receive both of the one or more sets of source data and stored data for processing.

As mentioned earlier, the device 120 can, for example, be configured to data communicate with the source portion 110 via the communication network 122. Thus the communication portion 130 can, for example, be coupled to the source portion 110 via the communication network 122.

The input portion 124 can be configured to communicate input signals to the processing portion 126. The processing portion 126 can be configured to process the input signals in a manner so as to produce control signals. The input portion 124 can, for example, be operated by a user in a manner so as to generate input signals which can be communicated to the processing portion 126. The input portion 124 can be one or both of software based and hardware based.

In one example, where the input portion 124 is software based, the input portion 124 can, for example, be a graphics user interface (GUI) which is displayable on the display portion 128. Based on the GUI, a user can operate the device 120 in a manner so as to generate input signals, as will be discussed in further detail later.

In another example, where the input portion 124 is hardware based, the input portion 124 can, for example, be a touch pad or a keyboard which is operable by a user in a manner so as to generate input signals. The input portion can also, for example, be an image capturing device such as a camera or a motion sensor which can be configured to generate input signals based on detected motion of a user. The input portion 124 will be discussed later in further detail.

Based on input signals communicated from the input portion 124, the processing portion 126, as mentioned earlier, can be configured to produce control signals. The control signals can be communicated from the processing portion 126 to one or both of the source portion 110 and the display portion 128.

The control signals can, for example, be communicated to the source portion 110 in a manner so as to control the source portion 110. For example, based on the control signals, one or more sets of source data can be communicated from the source portion 110 to the device 120. More specifically, for example, where the source portion 110 is a WWW source, one or more e-books can be downloaded from the source portion 110 via the communication network 122 to device 120 based on the control signals.

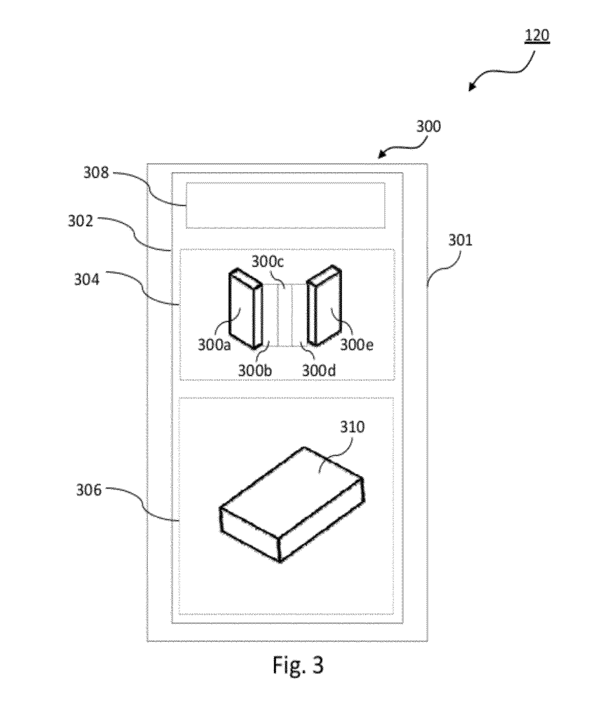

Additionally, the control signals can, for example, be communicated to the display portion 128 in a manner so as to control rendering of display at the display portion 128 as will be discussed later in further detail with reference to an exemplary implementation shown in FIG. 3.

The processing portion 126 can be configured to receive and process one or both of one or more sets of source data and stored data for processing in a manner so as to produce graphic data.

Graphic data can be communicated from the processing portion 126 to the display portion 128 in a manner such that the graphic data can be displayed on the display portion 128 as display data for viewing by a user of the device 120. Thus display data can correspond to a visual representation of a collection of e-books. Display data can further correspond to a visual representation of one or more e-books selected from the collection of e-books.

The display portion 128 can, in one embodiment, be a touch screen based display. Earlier mentioned, the input portion 124 can be software based. In this regard, based on a GUI displayed on the display portion 128, appropriate areas, on the display portion 128, corresponding to areas of the GUI can be contacted in a manner such that input signals can be generated.

The display portion 128 can, in another embodiment, be a non-touch screen based display. Earlier mentioned, the input portion 124 can be hardware based. In one embodiment, the input portion 124 can be a touch pad or a keyboard which can be operated by a user in a manner so as to generate input signals. For example, a GUI can be displayed on the display portion 128. Based on the combination of the GUI displayed on the display portion 128 and the, for example, touch pad, input signals can be generated. In another embodiment, the input portion 124 can be an image capturing device or a motion sensor which can be configured to detect motion of the user in a manner so as to generate input signals. In one example, the detected motion can be a gesture such as a hand of a user waving left or right. In another example, the detected motion can be a gesture such as a finger of a user flicking left or right.

Earlier mentioned, input signals can be communicated to the processing portion 126 for processing to produce control signals which can, for example, be communicated to the display portion 128 in a manner so as to control rendering of display at the display portion 128. Rendering of display at the display portion 128 and control thereof will be discussed in further detail hereinafter with reference to FIG. 3.

Further earlier mentioned, display data can correspond to a visual representation of a collection of e-books. Display data can further correspond to one or more e-books selected from the collection of e-books.

An exemplary implementation of the device 120 is shown in FIG. 3.

Referring to FIG. 3, the exemplary implementation of the device 120 can be such that the device 120 is an electronic reader device usable by a user. The electronic reader device can be an e-book reader 300 usable by a user for browsing one or more e-books. The e-book reader 300 can include a casing 301, a display screen 302 and a processer (not shown). The e-book reader 300 can further include a transceiver (not shown). The e-book reader 300 can yet further include a memory storage device (not shown).

The casing 301 can be shaped and dimensioned to carry the display screen 302 in a manner such that the user can view the display screen 302. The processer can be accommodated within the casing 301 and can be coupled to the display screen 302 for data communication therebetween. The transceiver and the memory storage device can also be accommodated within the casing 301.

The display screen 302 can correspond to the display portion 128. Furthermore, the display screen can, for example, be a touch-screen based display having a screen dimension. The screen dimension can be associated with a display area for displaying display data. The processor can correspond to the processing portion 126. The transceiver can correspond to the communication portion 130. The memory storage device can correspond to the database portion 132. In this regard, the above pertaining to the processing, display, communication and database portions 126/128/130/132 analogously applies.

The display screen 302 can be configured in various display configurations.

In a first exemplary display configuration, as shown, the display screen 302 can include a library display portion 304. Additionally, the display screen 302 can further include a preview display portion 306. The display screen can, optionally, yet further include a GUI portion 308.

The display screen 302 can be configured in a manner such that any of the library display portion 304, the preview portion 306 and the GUI portion 308, or any combination thereof, can be used to generate input signals. Specifically, the display screen 302 can be configured in a manner such that any one of or any combination of the library display portion 304, the preview display portion 306 and the GUI portion 308 can correspond to the input portion 124.

A collection of e-books can be displayed at the library display portion 304. The collection of e-books can, for example, include a first e-book 300a, a second e-book 300b, a third e-book 300c, a fourth e-book 300d and a fifth e-book 300e. Based on input signals, control signals can be generated for selecting an e-book from the collection of e-books. An e-book selected from the collection of e-books can be visually represented on the display portion 128 as a selected e-book 310. In this regard, the selected e-book 310 can correspond to any of the first to fifth e-books 300a/300b/300c/300d/300e.

The selected e-book 310 can be displayed at the preview display portion 306 in a manner such that a user of the e-book reader 300 can preview the selected e-book 310. Thereafter, the user can generate input signals in a manner so as to one of confirm selection of the selected e-book 310 and discard the selected e-book 310. Any one of or any combination of the library display portion 304, the preview display portion 306 and the GUI portion 308 can be used to generate input signals.

Where selection of the selected e-book 310 is confirmed, the display screen 302 can be configured to display the selected e-book 310 in a manner such that the display area of the display screen 302 can be optimized for displaying the selected e-book 310. For example, the entire display area or a substantial portion of the display area can be allocated to display the selected e-book 310. Otherwise, where the selected e-book 310 is to be discarded, the user can reselect another e-book from the collection of e-books displayed at the library display portion 304.

In this manner, e-book browsing can be facilitated in an efficient manner where optimized display of a selected e-book is not necessary until a confirmation is made by the user.

In a second exemplary display configuration, the display screen 302 can include the library display portion 304. Additionally, the display screen 304 can, optionally, further include the GUI portion 308. In this regard, the above description pertaining to the library display and preview display portions 304/308 analogously applies. Furthermore, the preview display portion 306 can be omitted.

In the second exemplary display configuration, upon selection of an e-book from the collection of e-books, the display screen 302 can be optimized for displaying the selected e-book 310. Appreciably, the display screen 302 can also be optimized for displaying the collection of e-books prior to a selection of an e-book from the collection of e-books. For example, the entire display area or a substantial portion of the display area can be allocated to display the collection of e-books or the selected e-book 310.

Moreover, in any of the first and second exemplary display configuration as discussed above, the user can position the selected e-book 310 in a manner so as to enhance visibility. The user can, for example, tilt the selected e-book 310 such that visibility can be enhanced.

Furthermore, the display screen 302 can be configured for one or both of plane based display and stereoscopic display in accordance with user preference. Specifically, based on input signals communicated to the processor, the display screen 302 can be configured for one or both of plane based display and stereoscopic display. Thus the display screen 302 can be in one or both of a plane based display mode and a stereoscopic display mode. In this regard, a user can control rendering of display at the display portion 128 in a manner such that the display screen 302 can be in one or both of the plane based display mode and the stereoscopic display mode.

When in the plane based display mode, the display screen 302 can be configured to display one or both of the collection of e-books and the selected e-book 310 via two dimensional (2D) imaging based graphic representation. Thus display data at the display screen can be associated with 2D imaging based graphic representation. The display data can correspond to one or both of the collection of e-books and the selected e-book 310.

When in stereoscopic display mode, the display screen 302 can be configured to display one or both of the collection of e-books and the selected e-book 310 via three dimensional (3D) imaging based graphic representation. Thus display data at the display screen can be associated with 3D imaging based graphic representation. The display data can correspond to one or both of the collection of e-books and the selected e-book 310.

In particular, the processor can be configured to process one or both of one or more sets of source data and stored data to produce graphic data in a manner such that display data corresponding to a 3D graphic representation of one or both of the collection of e-books and the selected e-book 310 can be visually perceived via the display screen 302.

Furthermore, the display screen 302, when configured for display in the stereoscopic display mode, can, for example, be associated with various conventional 3D viewer technologies. In one example, the display screen 302 can be associated with an active based 3D viewer technology. In another example, the display screen 302 can be associated with a passive based 3D viewer technology.

When associated with active based 3D viewer technology, the e-book reader 300 can be configured to usable with, for example, a pair of liquid crystal (LC) shutter glasses such that a user of the e-book reader 300 can, via the pair of LC shutter glasses, visually perceive display data displayed via 3D imaging based graphic representation. Specifically, via conventional techniques such as alternate frame sequencing, the pair of LC shutter glasses can, in synchronization with display data on the display screen 302, be configured to one of allow viewing and impede viewing in a manner such that a user can visually perceive display data displayed via 3D imaging based graphic representation.

When associated with passive based 3D viewer technology, the e-book reader 300 can be configured to be usable with, for example, a pair of polarized glasses such that a user of the e-book reader 300 can, via the pair of polarized glasses, visually perceive display data displayed via 3D imaging based graphic representation. The polarized glasses can be associated with polarization techniques such as orthogonal polarization and circular polarization. Specifically, the pair of polarized glasses can be a pair of conventional polarized 3D glasses which can be based on exploitation of polarization of light as well known in the art.

Although use of, for example, a pair of polarized glasses is discussed with respect to passive based 3D viewer technology, it is appreciable that for passive based 3D viewer technology, display data displayed via 3D imaging based graphic representation can also be visually perceived without the aid of polarized glasses. In this regard, the aforementioned passive based 3D viewer technology can, for example, be based on autostereoscopy.

Appreciably, display data displayed at the display screen 302 can be of a format suitable for any of the aforementioned various conventional 3D viewer technologies such as the active based 3D viewer technology and the passive based 3D viewer based technology.

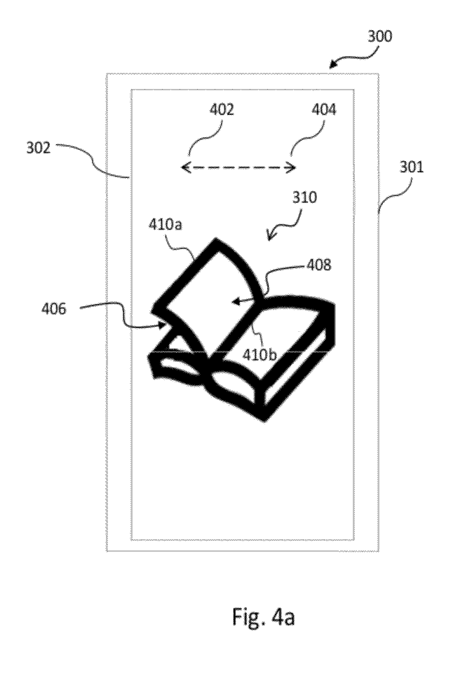

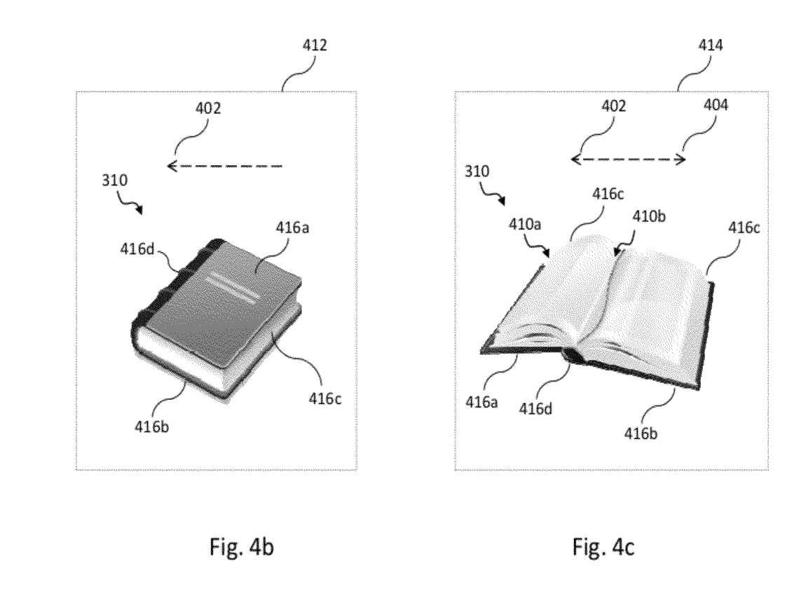

Yet furthermore, the display screen 302 can be configured such that display data can be displayed via various rendering strategies associated with 3D imaging based graphic representation. In this regard, the stereoscopic display mode can be associated with various rendering strategies as will be further discussed later with reference to FIG. 4.

Referring to FIG. 4a a first rendering strategy is shown. In the first rendering strategy, a user can generate input signals in a manner so as to flip digitally rendered pages of the selected e-book 310 in one of a first direction 402 and a second direction 404. Flipping of the digitally rendered pages of the selected e-book 310 in one of the first direction 402 and second direction 404 can be analogous to the user flipping pages of an equivalent paper based reading material. The first direction 402 can correspond to flipping in a forward direction and the second direction 404 can correspond to flipping in a reverse direction.

Moreover, each page of the paper based reading material can have a front side and a reverse side. Each of the front and reverse side can include one or both of literary works and pictorial illustrations In this regard, each digitally rendered page of the selected e-book 310 can correspondingly have a digital front side 406 and a digital reverse side 408. Thus, the digital front side and reverse side 406/408 of each digitally rendered page of the selected e-book 310 can include content data corresponding to the one or both of literary works and pictorial illustrations associated with the front and reverse side, respectively, of each corresponding page of the paper based reading material.

Additionally, each digitally rendered page can have a first edge 410a and a second edge 410b. The first edge 410a and the second edge 410b oppose each other. Thus when a digitally rendered page is flipped in either the first direction 402 or the second direction 404, the processor can be configured to produce graphic data such that the display data at the display screen 302 can correspond to a graphic representation where the first edge 410a can be visually perceived to be projecting from the display screen 302. In this manner a 3D graphic representation of the selected e-book 310 can be visually perceived.

Furthermore, to accentuate 3D visual perception of the selected e-book 310, the processor can further be configured to produce graphic data such that display data at the display screen 302 can further correspond to a graphic representation where the second edge 410b can be perceived to be recessed into the display screen 302, relative to the first edge 410a which can be visually perceived to be projecting from the display screen 302,

Yet furthermore, the processor can be configured to produce graphic data such that while flipping a digitally rendered page, content data associated with either the digital front side or the digital reverse side 406/408 of the digitally rendered page can be visually perceived depending on whether the digitally rendered page is flipped in the first direction 402 or the second direction 404.

In one example, a digitally rendered page can initially be visually represented such that the digital front side 406 and content data associated thereto can be visually perceived whereas the digital reverse side 408 and content data associated thereto cannot be visually perceived. The digitally rendered page can be flipped in the first direction 402 such that the digital reverse side 408 and content data associated thereto can be visually perceived instead of content data associated with the digital front side 406.

In another example, a digitally rendered page can initially be visually represented such that the digital reverse side 408 and content data associated thereto can be visually perceived whereas the digital front side 406 and content data associated thereto cannot be visually perceived. The digitally rendered page can be flipped in the second direction 404 such that the digital front side 406 and content data associated thereto can be visually perceived instead of content data associated with the digital reverse side 408.

Referring to FIG. 4b and FIG. 4c, a second rendering strategy is shown. The selected e-book 310 can be visually perceived to be in one of a closed representation 412 as shown in FIG. 4b and an open representation 414 as shown in FIG. 4c.

In the second rendering strategy, the selected e-book 310 can include a front cover 416a and a rear cover 416b. The selected e-book 310 can further include a plurality of digitally rendered pages 416c. The selected e-book 310 can yet further include a spine 416d.

When in the closed representation 412, the display data can correspond to a graphic representation where the plurality of digitally rendered pages 416c can be visually perceived to be between the front and rear covers 416a/416b. Furthermore, the front and rear covers 416a/416b can optionally be visually perceived to be coupled by the spine 416d.

Moreover, in the closed representation 412, the display data can correspond to a graphic representation where one of the front and rear covers 416a/416b, and at least one portion of the digitally rendered pages 416c can be visually represented to be projecting from the display screen 302. Furthermore, one portion of the spine 416d can optionally be visually perceived to be projecting from the display screen 302.

In this regard, depending on whether the front cover 416a or rear cover 416b is visually represented to be projecting from the display screen 302, the display data can further correspond to a graphical representation such that either corresponding one of the front cover and rear cover 416a/416b, and at least another portion of the plurality of digitally rendered pages 416c can be visually perceived to be recessed into the display screen 302. Furthermore, another portion of the spine 416d can optionally be visually perceived to be recessed into the display screen 302, relative to the portion of the spine 416d which can be visually perceived to be projecting from the display screen 302.

When in the open configuration 414, the display data can correspond to a graphic representation where at least a portion of the plurality of digitally rendered pages 416c can be visually perceived to be projecting from the display screen 302, whereas the front and rear covers 416a/416b can be visually perceived to be recessed into the display screen 302, relative to the portion of the plurality of digitally rendered pages 416c which is visually perceivable to be projecting from the display screen 302. In this regard, another portion of the plurality of digitally rendered pages 416c can be visually perceived to be recessed into the display screen 302, relative to the portion of the plurality of digitally rendered pages 416c which is visually perceivable to be projecting from the display screen 302. Similarly, the spine 416d can be visually perceived to be recessed into the display screen 302, relative to the portion of the plurality of digitally rendered pages 416c which is visually perceivable to be projecting from the display screen 302.

In one example, the display data can initially correspond to a graphic representation where the selected e-book 310 can be visually perceived to be in the closed representation 412. In this regard, the front cover 416a and at least one portion of the plurality of digitally rendered pages 416c can be visually perceived to be projecting from the display screen 302 whereas the rear cover 416b and at least another portion of the plurality of digitally rendered pages 416c can be visually perceived to be recessed into the display screen 302, relative to the front cover 416a. Additionally one portion of the spine 416d can be visually perceived to be projecting from the display screen 302 and another portion of the spine 416d can be visually perceived to be recessed into the display screen 302.

Input signals can be provided so as to generate control signals for flipping the selected e-book 310 from the closed representation 412 to the open representation 414. In this regard, the front cover 416a and one or more digitally rendered pages from the plurality of digitally rendered pages 416c can be flipped in the first direction 402 in a manner such that the plurality of digitally rendered pages 416c can be visually perceived to be projecting from the display screen 302 whereas the front and rear covers 416a/416b can be visually perceived to be recessed into the display screen 302, relative to the plurality of digitally rendered pages 416c. Similarly, the spine 416d can be visually perceived to be recessed into the display screen 302, relative to the plurality of digitally rendered pages 416c.

Furthermore, display data can, optionally, correspond to thickness of the selected e-book 310. Thickness of the selected e-book 310 can be determined by at least one of the aforementioned front cover 416a, rear cover 416b and digitally rendered pages 416c in either the closed representation 412 and open representation 414. For example, where the user flips one or more pages from the plurality of digitally rendered pages 416c in the first direction 402, the thickness can be perceived to be varied accordingly such that a side of the selected e-book 310 to which the one or more pages are flipped (i.e., in the first direction 402) can be visually perceived to be thicker than the side of the selected e-book 310 from which the one or more pages are flipped.

Moreover, each digitally rendered page of the plurality of digitally rendered pages 416c can have the aforementioned first edge 410a and second edge 410b. In this regard, the earlier discussion, with respect to the first rendering strategy, pertaining to flipping of digitally rendered pages of the selected e-book 310 analogously applies.

Other rendering strategies (not shown) are also useful.

In one example, the display data can be a graphic representation such that each of the first to fifth e-books 300a/300b/300c/300d/300e of the collection of e-books displayed at the the library display portion 304 can be visually perceived to be projecting from the display screen 302.

In another example, the display data can be a graphic representation such that the front cover 416a, the rear cover 416b, the plurality of digitally rendered pages 416c and the spine 416d can be visually perceived to be projecting from the display screen 302.

Via the aforementioned various rendering strategies associated with 3D imaging based graphic representation, a user of the e-book reader 300 can appreciably be afforded an enhanced browsing experience. Specifically, a user can be provided with a realistic browsing experience where display data associated with one or both of the collection of e-books and the selected e-book 310 can be graphically displayed at the display screen 302 via 3D imaging based graphic representation.

Additionally, in any of the aforementioned various rendering strategies, the processor can be configured to produce graphic data such that while flipping a digitally rendered page, at least a portion of content data associated with either the digital front side or the digital reverse side 406/408 of the digitally rendered page can be visually perceived to be one of projecting from the display screen 302 and recessed into the display screen 302.

For example, an e-book can be of a genre related to the subject matter of biology. In this regard, content data of the e-book can correspond to a pictorial illustration of a human body and accompanying literary works explaining functions of different parts of the human body. The processor can, for example, be configured to produce graphic data such that the pictorial illustration of the human body can be visually perceived to be projecting from the display screen 302 while the accompanying literary works can be visually perceived to be recessed into the display screen 302. Appreciably, the processor can also, for example, be configured to produce graphic data such that the pictorial illustration of the human body can be visually perceived to be recessed into the display screen 302 while the accompanying literary works can be visually perceived to be projecting from the display screen 302.

As mentioned above, at least a portion of content data can be visually perceived to be one of projecting from the display screen 302 and recessed into the display screen 302. Thus, it is appreciable that the system 100 can be useful for facilitating viewing of content data by a user with presbyopia (i.e., farsightedness) or shortsightedness. In this regard, the input portion 124 can be further configured to communicate input signals to the processing portion 126 for processing to produce control signals such that the extent of which the at least a portion of content data which can be visually perceived to be one of projecting from the display screen 302 and recessed into the display screen 302 can be varied in accordance with user preference.

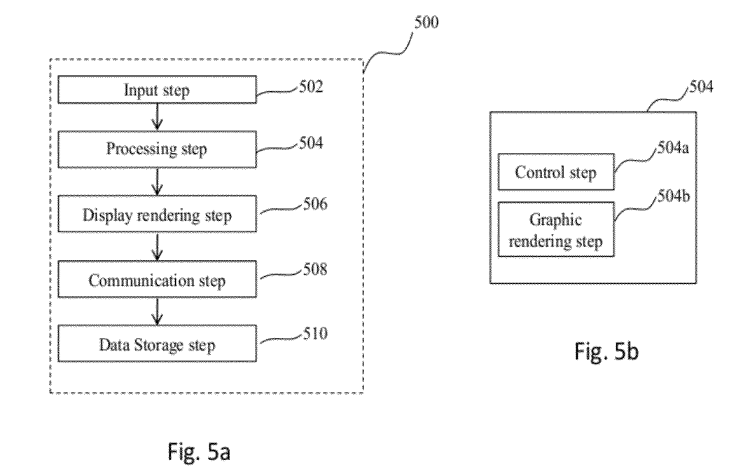

In accordance with another embodiment of the disclosure, a processing method 500, as shown in FIG. 5a and FIG. 5b, can be implemented in association with the system 100.

As shown in FIG. 5a, the processing method 500 can include an input step 502, a processing step 504 and a display rendering step 506. The method 500 can further include a communication step 508 and a data storage step 510. Furthermore, as shown in FIG. 5b, the processing step 504 can include a control step 504a and a graphic rendering step 504b.

At the input step 502, input signals can be generated via the input portion 124.

At the processing step 504, one or both of control signals and graphic data can be produced and communicated from the processing portion 126.

Specifically, at the control step 504a, input signals can be received and processed by the processing portion 126 to produce control signals.

Additionally, at the graphic rendering step 504b, in one embodiment, one or more sets of source data can be received and processed by the processing portion 126 in a manner so as to produce graphic data. In another embodiment, at the graphic rendering step 504b, one or more sets of stored data can be received and processed by the processing portion 126 in a manner so as to produce graphic data. In yet another embodiment, one or more sets of source data and one or more sets of stored data can be received and processed by the processing portion 126 in a manner so as to produce graphic data.

At the display rendering step 506, graphic data can be communicated to the display portion 128 in a manner such that the graphic data can be displayed on the display portion 128 as display data.

Furthermore, at the communication step 508, the device 120 can be configured to data communicate with the source portion 110 via the communication network 122 such that one or more sets of source data can be communicated from the source portion 110 to the device 120.

Moreover, at the data storage step 510, one or more sets of source data can be received by the database portion 132 for storage therein as corresponding one or more sets of stored data.

In the foregoing manner, various embodiments of the disclosure are described for addressing at least one of the foregoing disadvantages. Such embodiments are intended to be encompassed by the following claims, and are not to be limited to specific forms or arrangements of parts so described and it will be apparent to one skilled in the art in view of this disclosure that numerous changes and/or modification can be made, which are also intended to be encompassed by the following claims.

1. An electronic reader device configurable to receive at least one set of source data for processing in a manner so as to display at least one electronic reading material, the electronic reader device comprising:
a processing portion configurable to process at least one set of source data in a manner so as to produce graphic data; and
a display portion coupled to the processing portion, graphic data being communicable from the processing portion to the display portion, the display portion being configurable to display graphic data as display data in a stereoscopic display mode,
the display data corresponding to a graphic representation,
wherein in the stereoscopic display mode, the graphic representation is associable with a three dimensional imaging based graphic representation such that the display data correspond to a graphic representation where at least one portion of the at least one electronic reading material is visually perceivable to be projecting from the display portion.

2. The electronic reader device as in claim 1, wherein the display data further correspond to a graphic representation where at least another portion of the at least one electronic reading material is visually perceivable to be recessed into the display portion relative to the at least one portion of the at least one electronic reading material which is visually perceivable to be projecting from the display portion.

3. The electronic reader device as in claim 2,
wherein the at least one electronic reading material comprises a plurality of digitally rendered pages, each of the plurality of digitally rendered pages having a first edge and a second edge; and
wherein at least one portion of the at least one electronic reading material is visually perceivable to be projecting from the display portion such that the first edge of a digitally rendered page is visually perceivable to be projecting from the display portion when the digitally rendered page is flipped in one of a first direction and a second direction.

4. The electronic reader device as in claim 3,
wherein at least another portion of the at least one electronic reading material is visually perceivable to be recessed into the display portion such that the second edge of the digitally rendered page is visually perceivable to be recessed into the display portion when the digitally rendered page is flipped in one of the first and the second direction.

5. An electronic reader device configurable to receive at least one set of source data for processing in a manner so as to display at least one electronic reading material which includes a plurality of digitally rendered pages, each of the plurality of digitally rendered pages having a first edge and a second edge, the electronic reader device comprising:
a processing portion configurable to process at least one set of source data in a manner so as to produce graphic data; and
a display portion coupled to the processing portion, graphic data being communicable from the processing portion to the display portion, the display portion being configurable to display graphic data as display data, the display data corresponding to a graphic representation where the first edge of a digitally rendered page is visually perceivable to be projecting from the display portion when the digitally rendered page is flipped in one of a first direction and a second direction.

6. The electronic reader device as in claim 5, wherein the display data further corresponds to a graphic representation where, relative to the first edge which is visually perceivable to be projecting from the display portion, the second edge of one of the plurality of digitally rendered pages is visually perceivable to be recessed into the display portion when the digitally rendered page is flipped in one of the first direction and the second direction.

7. The electronic reader device as in claim 6, wherein the at least one electronic reading material corresponds to a collection of electronic books (e-books) and each e-book from the collection of e-books comprises a front cover and a rear cover.

8. The electronic reader device as in claim 7, wherein an e-book is selectable from the collection of e-books and the display data further corresponds to a graphic representation where the selected e-book is visually perceivable to be in one of a closed representation and an open representation.

9. The electronic reader device as in claim 8, wherein when in the closed representation, the display data correspond to a graphic representation where the plurality of digitally rendered pages can be visually perceived to be between the front and rear covers.

10. The electronic reader device as in claim 9, the display data further corresponding to a graphic representation where at least a portion of the plurality of digitally rendered pages, and one of the front cover and the rear cover are visually perceivable to be projecting from the display portion.

11. The electronic reader device as in claim 10, the display data yet further corresponding to a graphic representation where another portion of the plurality of digitally rendered pages and corresponding one of the front cover and the rear cover which opposes either of the front and rear covers visually perceivable to be projecting from the display portion, are visually perceivable to be recessed into the display portion.

12. The electronic reader device as in claim 11, wherein each e-book from the collection of e-books further comprises a spine which couples the front and rear covers.

13. The electronic reader device as in claim 12, wherein the display data correspond to a graphic representation where at least a portion of the spine is visually perceivable to be projecting from the display portion and another portion of the spine is visually perceivable to be recessed into the display portion.

14. The electronic reader device as in claim 8, wherein when in the open representation, the display data correspond to a graphic representation where at least a portion of the plurality of digitally rendered pages is visually perceivable to be projecting from the display portion whereas another portion of the plurality of digitally rendered pages, the front cover and the rear cover are visually perceivable to be recessed into the display portion, relative to the portion of the plurality of digitally rendered pages visually perceivable to be projecting from the display portion.

15. The electronic reader device as in claim 14, wherein each e-book from the collection of e-books further comprises a spine which couples the front and rear covers.

16. The electronic reader device as in claim 15, wherein the display data correspond to a graphic representation where the spine is visually perceivable to be recessed into the display portion.

17. The electronic reader device as in claim 5, wherein the electronic reader device is an e-book reader.

18. An electronic reader device configurable to receive at least one set of source data for processing in a manner so as to display at least one electronic reading material which includes a plurality of digitally rendered pages, each of the plurality of digitally rendered pages having a first edge and a second edge, the electronic reader device comprising:
a processing portion configurable to process at least one set of source data in a manner so as to produce graphic data; and
a display portion coupled to the processing portion, graphic data being communicable from the processing portion to the display portion, the display portion being configurable to display graphic data as display data in one of a plane based display mode and a stereoscopic display mode, the display data corresponding to a graphic representation,
wherein when in the plane based display mode, the graphic representation is associable with a two dimensional imaging based graphic representation, and
wherein when in the stereoscopic display mode, the graphic representation is associable with a three dimensional imaging based graphic representation.

19. The electronic reader device as in claim 18, wherein when in the stereoscopic display mode, the three dimensional imaging based graphic representation is such that the first edge of a digitally rendered page is visually perceivable to be projecting from the display portion when the digitally rendered page is flipped in one of a first direction and a second direction.

20. The electronic reader device as in claim 19, wherein when in the stereoscopic display mode, the three dimensional imaging based graphic representation is such that the second edge of the digitally rendered page is visually perceivable to be recessed into the display portion when the digitally rendered page is flipped in one of the first and the second direction.
